(19) United States
(12) Patent Application Publication
(10) Pub. No.: US 2005/0228695 A1
(43) Pub. Date: Oct. 13, 2005

(54) Hospital management apparatus and method, and computer-readable medium

(75) Inventor: Tomohiko Ito, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/014,858

(22) Filed: Dec. 20, 2004

(30) Foreign Application Priority Data
Dec. 18, 2003 (JP) P.2003-420430

(51) Int. Cl. G06F 17/60

(52) U.S. Cl. 705/2

(57) ABSTRACT

A hospital management apparatus connected to a plurality of medical devices installed in a hospital through a local area network so as to manage said plurality of medical devices, said hospital management apparatus comprises: an anti-virus unit that provides anti-virus measures for said plurality of medical devices; and an accounting information generating unit that generates accounting information for accounting in accordance with the anti-virus measures.

### BACKGROUND OF THE INVENTION

1. Field of the Invention

The present invention relates to hospital management apparatus connected via a local area network to a plurality of medical devices installed in a hospital and for managing the plurality of medical devices, and a hospital management program for implementing the hospital management apparatus by means of a computer.

2. Description of the Related Art

In recent years, a plurality of medical devices installed in a hospital are connected to the Internet so that each medical device can acquire various kinds of information through the Internet. Since the plurality of in medical devices are connected to the Internet, anti-virus measures are essential for any medical device. In the hospital, the plurality of medical devices are managed by different management agents respectively. In the background art, therefore, each management agent installs anti-virus software in medical devices managed by the management agent in advance. Each medical device gains periodic access to a server of a company making up the anti-virus software, so as to acquire a latest pattern file. Thus, anti-virus measures are taken.

Japanese Patent Laid-Open No. 2002-83058 is a document related to anti-virus measures in a hospital.

Hospitals handle important information about privacy or personal births and deaths. It is therefore not desired that medical devices individually gain periodic access to servers through the Internet like the background art. In addition, a management agent managing a plurality of medical devices has to take anti-virus measures individually. For this reason, the management agent managing the plurality of medical devices has to take care of expenses for the anti-virus measures on each of the plurality of medical devices managed by the management agent itself. Thus, a heavy burden is imposed on the management agent.

### SUMMARY OF THE INVENTION

The invention was developed in consideration of the foregoing circumstances. It is an object of the invention to provide hospital management apparatus which is capable of relieving the burden imposed on management agents for anti-virus measures taken on medical devices installed in a hospital, and which is capable of protecting information in the hospital, and a computer-readable medium for implementing the hospital management apparatus by means of a computer.

According to the invention, there is provided a hospital management apparatus connected to a plurality of medical devices installed in a hospital through a local area network so as to manage said plurality of medical devices, said hospital management apparatus comprising: an anti-virus unit that provides anti-virus measures for said plurality of medical devices; and an accounting information generating unit that generates accounting information for accounting in accordance with the anti-virus measures.

According to the invention, there is provided the hospital management apparatus, further comprising: a storage unit that stores past records information indicating past records of the anti-virus measures; wherein the accounting information generating unit generates the accounting information for accounting in accordance with the past records of the anti-virus measures, based on the past records information stored in the storage unit.

According to the invention, there is provided the hospital management apparatus, wherein anti-virus software is installed in said plurality of medical devices; the anti-virus unit acquires a latest pattern file made up for the anti-virus software, and sends the pattern file to requesting one(s) of said plurality of medical devices via the local area network; the past records information includes information indicating a number of times of sending the pattern file to each of said plurality of medical devices; and the accounting information generating unit generates the accounting information for charging each of management agents of said plurality of medical devices a fee corresponding to the number of times of sending the pattern file for each of said plurality of medical devices.

According to the invention, there is provided the hospital management apparatus, wherein anti-virus software is installed in each of said plurality of medical devices; the anti-virus unit acquires a latest pattern file made up for the anti-virus software, and sends the pattern file to requesting one(s) of said plurality of medical devices via the local area network; the past records information includes information indicating a number of times of sending the pattern files; and the accounting information generating unit generates accounting information for charging a manager of the hospital a fee corresponding to the number of times of sending the pattern files.

With this configuration, it is possible to relieve the burden on the management agents for the anti-virus measures on the medical devices installed in the hospital, and protect information in the hospital.

According to the invention, there is provided the hospital management apparatus, further comprising: an output unit that outputs the past records information stored in the storage unit.

With this configuration, the information indicating the past records of the anti-virus measures is output. Accordingly, each management agent managing a plurality of medical devices can know what anti-virus measures have been taken.

According to the invention, there is provided the hospital management apparatus, further comprising: a storage unit that stores measures contents information for specifying contents of anti-virus measures to be taken for each of said plurality of medical devices, wherein the anti-virus unit provides the anti-virus measures in accordance with the contents specified by the measures contents information stored in the storage unit; and the accounting information generating unit generates the accounting information for charging each of management agents of said plurality of medical devices a fee corresponding to the contents of the anti-virus measures specified for each of said plurality of medical devices, based on the measures contents information stored in the storage unit.

According to the invention, there is provided the hospital management apparatus, wherein no anti-virus software is installed in each of said plurality of medical devices; the anti-virus software is installed in the hospital management apparatus; and the contents of the anti-virus measures include acquisition of a latest pattern file made up for the anti-virus software, detection of viruses in said plurality of medical devices by means of the pattern file, and extermination of the detected viruses in said plurality of medical devices by means of the pattern file.

With this configuration, a fee corresponding to the contents of the anti-virus measures to be taken for the plurality of medical devices can be charged on each management agent of the plurality of medical devices or the manager of the hospital.

According to the invention, there is provided a hospital management apparatus, further comprising: an operational status information acquisition unit that acquires operational status information indicating operational status of each of said plurality of medical devices from a server for monitoring the operational status of each of said plurality of medical devices, the server being connected to the local area network; wherein the accounting information generating unit corrects the generated accounting information in accordance with the operational status based on the operational status information.

According to the invention, there is provided the hospital management apparatus, wherein the accounting information generating unit corrects the generated accounting information in accordance with operational status of the hospital management apparatus.

With this configuration, the accounting information is corrected in accordance with the operational status of the plurality of medical devices or the hospital management apparatus. Accordingly, it is possible to provide a service in which a fee to be charged is discounted in accordance with the period when the plurality of medical devices or the hospital management apparatus is powered off.

According to the invention, there is provided the hospital management apparatus, further comprising: a storage unit that stores medical device information indicating management agents of said plurality of medical devices individually; wherein the accounting information generating unit generates the accounting information for charging each of the management agents a fee corresponding to a number of medical devices managed by the management agents, based on medical device information stored in the storage unit.

According to the invention, there is provided the hospital management apparatus, wherein the accounting information generating unit generates the accounting information for charging a manager of the hospital a fee corresponding to a number of said plurality of medical devices.

According to the invention, there is provided the hospital management apparatus, further comprising: a storage unit that stores medical device information indicating kinds and management agents of said plurality of medical devices individually; wherein the accounting information generating unit generates accounting information for charging each of the management agents a fee corresponding to a number of kinds of medical devices managed by the management agents, based on the medical device information stored in the storage unit.

The hospital management apparatus according to the invention further includes a storage unit for storing information indicating kinds of the plurality of medical devices individually; wherein the accounting information generating unit generates accounting information for charging a manager of the hospital a fee corresponding to a number of kinds of the plurality of medical devices, based on the information stored in the storage unit.

According to the invention, there is provided the hospital management apparatus, further comprising: an output unit that outputs information indicating past records of the anti-virus measures taken by the anti-virus unit.

According to the invention, there is provided a hospital management method for managing a plurality of medical devices installed in a hospital, the method comprising: connecting at least one of said plurality of medical devices through a local area network, to provide anti-virus measures for said at least one of said plurality of medical devices; and generating accounting information for accounting in accordance with the anti-virus measures.

According to the invention, there is provided a computer-readable medium comprising a set of instructions for executing the methods of the present invention. For achieving the methods of the present invention, the hospital management apparatus may be an equipment provided with a computer embodied by installing a program corresponding to the set of instructions.

### BRIEF DESCRIPTION OF THE DRAWINGS

FIG. 1 is a diagram showing the schematic configuration of a hospital management system for explaining a first embodiment of the invention;

FIG. 2 is a diagram showing an accounting table stored in a database of hospital management apparatus in the hospital management system for explaining the first embodiment of the invention;

FIG. 3 is a flow chart of the operation of the hospital management system for explaining the first embodiment of the invention;

FIG. 4 is a diagram showing the schematic configuration of a hospital management system for explaining a second embodiment of the invention;

FIG. 5 is a diagram showing an accounting table stored in a database of hospital management apparatus in the hospital management system for explaining the second embodiment of the invention; and

FIG. 6 is a flow chart of the operation of the hospital management system for explaining the second embodiment of the invention.

### DETAILED DESCRIPTION OF THE INVENTION

Hospital management systems for explaining embodiments of the invention will be described below with reference to the drawings.

### First Embodiment

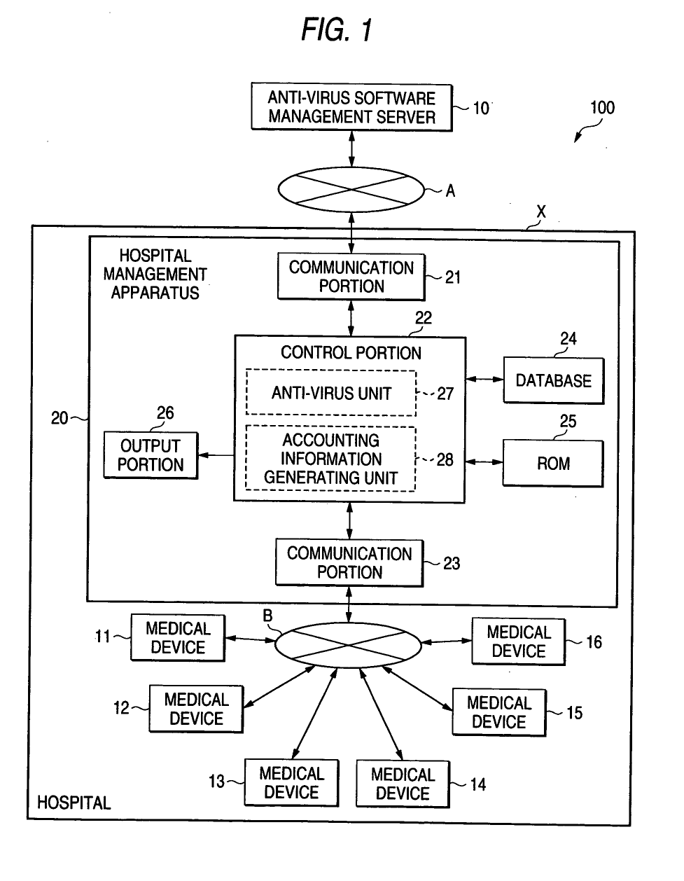

FIG. 1 is a diagram showing the schematic configuration of a hospital management system for explaining a first embodiment of the invention.

A hospital management system 100 has an anti-virus software management server 10, a network A such as the Internet, a plurality of medical devices 11 to 16, and hospital management apparatus 20. The anti-virus software management server 10 is operated by a company making up anti-virus software (vaccine) The hospital management apparatus 20 is connected to the plurality of medical devices 11 to 16 via a local area network B such as Intranet so as to manage the plurality of medical devices 11 to 16. The hospital management apparatus 20, the local area network B and the plurality of medical devices 11 to 16 are installed in a hospital X. The hospital management apparatus 20 may be provided outside the hospital.

The anti-virus software management server 10 makes up a latest pattern file for the anti-virus software and sends the latest pattern file to the hospital management apparatus 20 in accordance with a request from the hospital management apparatus 20.

The plurality of medical devices 11 to 16 are devices to be used for medical applications. Each medical device includes a computer. An image management server or the like for managing medical image data such as roentgenogram data is also one of the medical devices. A latest version of the anti-virus software is installed in each of the plurality of medical devices 11 to 16. The anti-virus software has a function of gaining periodic access to the hospital management apparatus 20 and requesting the hospital management apparatus 20 to send the latest pattern file. The anti-virus software also has a function of sending its own version information together with the aforementioned request.

The medical device 11 is managed by a management agent a, the medical device 12 is managed by a management agent b, the medical devices 13 to 15 are managed by a management agent c, and the medical device 16 is managed by a management agent d. The hospital X is managed by a manager e.

The hospital management apparatus 20 has a communication portion 21, a control portion 22, a communication portion 23, a database 24, a ROM 25 and an output portion 26. The control portion 22 further includes an anti-virus unit 27 and an accounting information generating unit 28.

The communication portion 21 has communication with devices outside the hospital X through the network A. The anti-virus software management server 10 is one of such devices. The communication portion 23 has communication with the plurality of medical devices 11 to 16 through the local area network B.

The control portion 22 which includes the anti-virus unit 27 and the accounting information generating unit 28 is mainly constituted by a processor operating by a predetermined program stored in the ROM 25. The control portion 22 supervises and controls the hospital management apparatus 20 as a whole. The control portion 22 registers information (IDs for specifying the medical devices, IDs for specifying the management agents, and information such as types of the medical devices) into the database 24. The information is input by the management agents of the plurality of medical devices 11 to 16 individually. The anti-virus unit 27 of the control portion 22 takes anti-virus measures for the plurality of medical devices 11 to 16 registered in the database 24. The anti-virus measures mean that the latest pattern file acquired from the anti-virus software management server 10 is sent through the local area network B to a requesting one of the plurality of medical devices 11 to 16 registered in the database 24. The latest pattern file acquired from the anti-virus software management server 10 is stored in the database 24.

The control portion 22 stores information indicating past records of the anti-virus measures (the number of times of sending the latest pattern file) into the database 24 whenever the latest pattern file is sent.

The accounting information generating unit 28 of the control portion 22 generates accounting information for charging each management agent a-d of the plurality of medical devices 11 to 16 a fee corresponding to the number of times of sending the pattern file to each of the plurality of medical devices 11 to 16, based on the information indicating the past records of the virus measures and stored in the database 24. The generated accounting information is stored in the data base 24. The accounting information stored thus is output by the output portion 26 so as to be used as information for charging each management agent a-d a fee for the anti-virus measures.

Incidentally, the control portion 22 may wholly or partially be a general purpose computer containing a program corresponding to the set of instructions for the function as set forth above. For example, at least one of anti-virus unit 27 and the accounting information generating unit 28 can be a general purpose computer containing such a program.

In addition, the hospital management apparatus 20 may be wholly or partially located outside the hospital. For example, but not by way of limitation, at least one of the control portion 22, the database 24, the ROM 25 and the output portion 26 can be located outside the hospital.

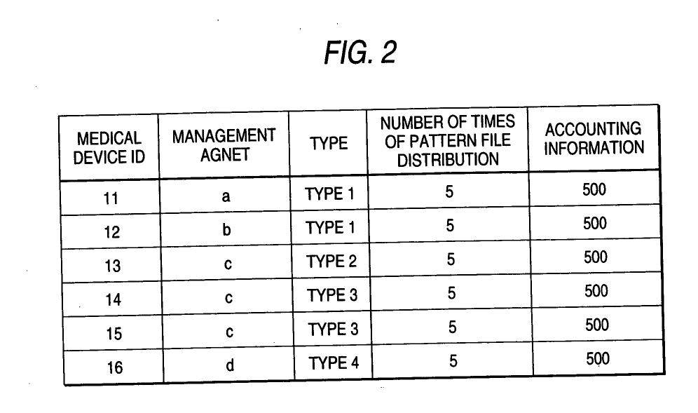

FIG. 2 is a diagram showing an example of an accounting table stored in the database 24.

As shown in FIG. 2, the database 24 stores an accounting table including the IDs of the plurality of medical devices 11 to 16, the IDs of the management agents a to d managing the plurality of medical devices 11 to 16 respectively, the information indicating types of the plurality of medical devices 11 to 16 respectively, the information indicating the number of times of sending the pattern file to each of the plurality of medical devices 11 to 16, and the accounting information for accounting in accordance with the number of times of sending. In this embodiment, description will be made on the assumption that a fee for sending the pattern file once is 100 yen.

The information indicating the types is information indicating the kind etc. of OS (Operating System) in the computer of each of the plurality of medical devices 11 to 16.

The output portion 26 outputs the accounting information or the information indicating the past records of the anti-virus measures. For example, the output portion 26 prints out the accounting information or the information indicating the past records of the anti-virus measures on paper.

Description will be made below about the operation of the hospital management system 100.

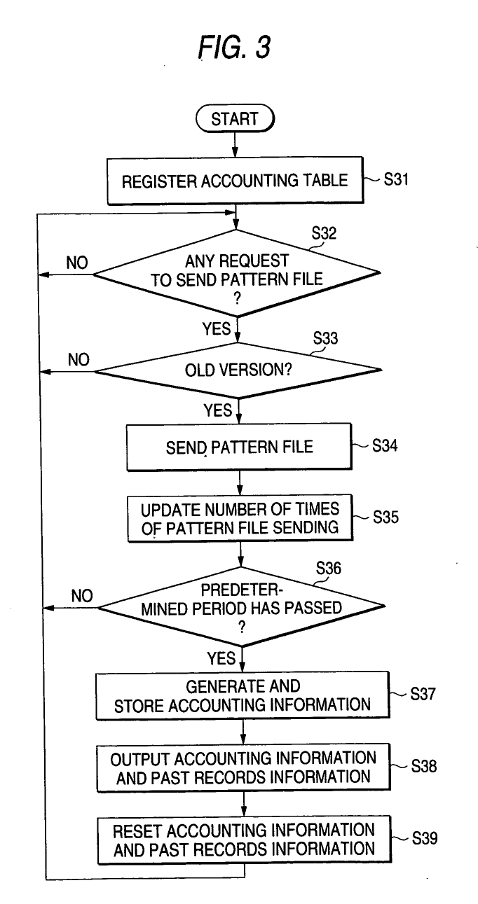

FIG. 3 is a flow chart for explaining the operation of the hospital management system 100.

First, each management agent a-d uses its own PC (personal computer) or the like to gain access to the hospital management apparatus 20 through the network B. The management agent a-d inputs the ID of a medical device managed by the management agent, the ID of the management agent, and information of the type of the medical device into the hospital management apparatus 20. The control portion 22 of the hospital management apparatus 20 makes up an accounting table based on the input information, and registers the accounting table into the database 24 (S31).

After the registration, the anti-virus unit 27 of the control portion 22 gains access to the anti-virus software management server 10 via the communication portion 21 and the network A periodically (for example, every six hours). When the pattern file has been updated, the anti-virus unit 27 of the control portion 22 performs a pattern file acquisition process for acquiring the latest pattern file from the anti-virus software management server 10 via the network A and the communication portion 31.

In parallel to the pattern file acquisition process, the anti-virus unit 27 of the control portion 22 determines whether a request to send the pattern file has been issued from a medical device registered in the database 24 or not. When there is a request to send (S32: YES), the version of the pattern file possessed by the requesting medical device is determined from the version information sent from the medical device (S33). When the version of the pattern file possessed by the medical device having issued the request to send is not identical to that of the latest pattern file but older (S33: YES), the latest pattern file is sent to the medical device (S34). When the version of the pattern file possessed by the medical device having issued the request to send is identical to that of the latest pattern file (S33: NO), the latest pattern file is not sent, but the process is moved to S32. Incidentally, when a request to send the pattern file is issued from a medical device that is not registered in the database 34 the control portion 22 does not accept the request to send.

After the pattern file is sent, the control portion 22 updates, of items in the accounting table, an item about the number of times of sending the pattern file to the medical device to which the pattern file was sent (S35). The control portion 22 determines whether a predetermined period (for example, one month) has passed since the accounting table was registered in the data base 24 or not (S36). The steps S32 to S36 are repeated till the predetermined period has passed.

When the predetermined period has passed since the accounting table was registered in the database 24 (S36: YES), the accounting information generating unit 28 of the control portion 22 generates accounting information for charging each management agent a-d a fee corresponding to the number of times of sending the pattern file to each of the plurality of medical devices 11 to 16, based on the information about the number of times of sending the pattern file which information is stored in the accounting table. The generated accounting information is stored in the accounting table (S37).

In the example of FIG. 2, the number of times of sending the pattern file to each of the plurality of medical devices 11 to 16 is five. Therefore, accounting information for charging each of the management agents a, b and d 500 yen, and charging the management agent c 1,500 yen is generated and stored. The accounting information may be generated as soon as the predetermined period has passed or whenever the number of times of sending the pattern file is updated.

After storing the accounting information, the control portion 22 makes the output portion 26 output the stored accounting information and the information indicating the number of times of sending the pattern file to each of the plurality of medical devices 11 to 16 (S38). As a result, a report in which the accounting information and the information indicating the number of times of sending the pattern file to each of the plurality of medical devices 11 to 16 have been printed can be presented to each management agent a-d. After that, the control portion 22 resets the item about the number of times of sending the pattern file and the item about the accounting information in the accounting table (S39). Then, the process is moved to S32.

Thus, according to the hospital management system 100, the hospital management apparatus 20 sends the latest pattern file to the plurality of medical devices 11 to 16, and generates accounting information for charging each of the management agents a to d of the plurality of medical devices 11 to 16 a fee corresponding to the number of times of sending the pattern file. Each of the plurality of medical devices 11 to 16 can take anti-virus measures sufficiently without gaining periodic access to the anti-virus software management server 10 individually. It is therefore possible to secure safety in information handled in the hospital. In addition, it is possible to charge each of the management agents of the plurality of medical devices 11 to 16 a fee corresponding to the number of times of sending the pattern file to each of the plurality of medical devices 11 to 16 based on the accounting information. Thus, each management agent managing a plurality of medical devices does not have to manage expenses required for anti-virus measures for the plurality of medical devices. It is therefore possible to relieve the burden on the management agent.

Although a user to be charged is each management agent a-d in the aforementioned embodiment, the manager e of the hospital X may be set as the user to be charged. In this case, it will go well if the control portion 22 operates as follows. That is, in S37 in FIG. 3, based on the accounting table, the accounting information generating unit 28 of the control portion 22 obtains the sum of the numbers of times of sending the pattern file to the plurality of medical devices 11 to 16, and generates accounting information for charging the manager e of the hospital X a fee corresponding to the sum. Then, the control portion 22 stores the accounting information in the database 24.

Although accounting information for accounting in accordance with past records of the anti-virus measures is generated in the aforementioned embodiment, accounting information for accounting in accordance with the number of medical devices to be subjected to the anti-virus measures regardless of the past records of the anti-virus measures may be generated.

For example, as soon as the accounting table is registered in S31 of FIG. 3, the control portion 22 generates accounting information for charging each management agent a-d a fee corresponding to the number of medical devices managed by the management agent a-d, based on the accounting table, and stores the accounting information into the database 24.

In this case, the step S37 in FIG. 3 is omitted, and in S38 the generated accounting information is output together with the information indicating the past records of the anti-virus measures. Description will be made using the example of FIG. 2 on the assumption that a fee to be charged for anti-virus measures on one medical device is 1,000 yen per month. Since the management agent c manages three medical devices, the accounting information generating unit 28 of the control portion 22 generates accounting information for charging the management agent c 3,000 yen per month, and generates accounting information for charging each of the other management agents 1,000 yen per month.

When the manager e has been set as the user to be charged, as soon as the accounting table is registered in S31 of FIG. 3, the accounting information generating unit 28 of the control portion 22 obtains the number of the plurality of medical devices 11 to 16 and generates accounting information for charging the manager e a fee corresponding to the obtained number, based on the accounting table. Then, the control portion 22 stores the accounting information into the database 24. In this case, the step S37 in FIG. 3 is omitted, and in S38 the generated accounting information is output together with the information indicating the past records of the anti-virus measures. Description will be made using the example of FIG. 2 on the assumption that a fee to be charged for anti-virus measures on one medical device is 1,000 yen per month. Since the number of the plurality of medical devices 11 to 16 is six, the accounting information generating unit 28 of the control portion 22 generates accounting information for charging the manager e 6,000 yen per month.

Alternatively, accounting information for accounting in accordance with the number of types of medical devices to be subjected to the anti-virus measures regardless of the past records of the anti-virus measures may be generated.

For example, as soon as the accounting table is registered in S31 of FIG. 3, the control portion 22 generates accounting information for charging each management agent a-d a fee corresponding to the number of types of medical devices managed by the management agent a-d, based on the accounting table, and stores the accounting information into the database 24. In this case, the step S37 in FIG. 3 is omitted, and in S38 the generated accounting information is output together with the information indicating the past records of the anti-virus measures. Description will be made using the example of FIG. 2 on the assumption that a fee to be charged for anti-virus measures on one medical device type is 1,000 yen per month. Since the management agent c manages two types of medical devices, the accounting information generating unit 28 of the control portion 22 generates accounting information for charging the management agent c 2,000 yen per month, and generates accounting information for charging each of the other management agents 1,000 yen per month.

When the manager e has been set as the user to be charged, as soon as the accounting table is registered in S31 of FIG. 3, the accounting information generating unit 28 of the control portion 22 obtains the total number of types of the plurality of medical devices 11 to 16 and generates accounting information for charging the manager e a fee corresponding to the obtained total number, based on the accounting table. Then, the control portion 22 stores the accounting information into the database 24. In this case, the step S37 in FIG. 3 is omitted, and in S38 the generated accounting information is output together with the information indicating the past records of the anti-virus measures. Description will be made using the example of FIG. 2 on the assumption that a fee to be charged for anti-virus measures on one medical device type is 1,000 yen per month. Since the plurality of medical devices 11 to 16 include four types, the accounting information generating unit 28 of the control portion 22 generates accounting information for charging the manager e 4,000 yen per month. It can be considered that different types of anti-virus software are installed in medical devices in accordance with types of the medical devices. Therefore, accounting in accordance with the number of types in such a manner can be regarded as a useful service.

In addition, in this embodiment, the aforementioned predetermined period may be set for each management agent a-d individually.

In addition, in this embodiment, of the plurality of medical devices registered in the database 24, some specific medical devices may be set so that the pattern file is sent thereto without charge.

In this embodiment, the control portion 22 acquires the latest pattern file from the anti-virus software management server 10. However, a recording medium recording the latest pattern file may be brought directly into the hospital X by a person, and the control portion 22 may acquire the latest pattern file from the recording medium.

### Second Embodiment

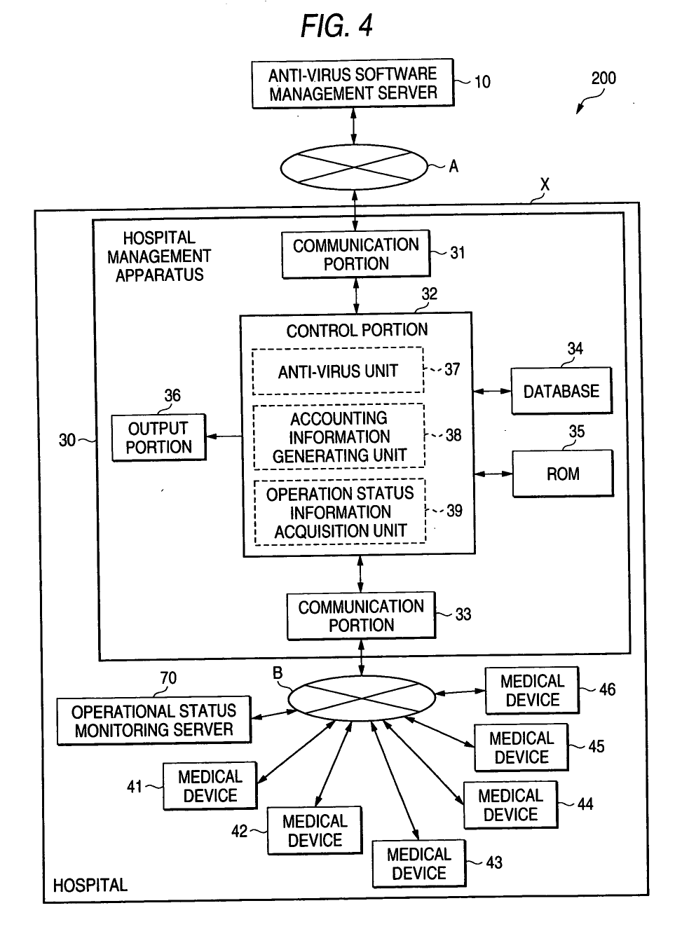

FIG. 4 is a diagram showing the schematic configuration of a hospital management system for explaining a second embodiment of the invention. Description will be made while constituent parts similar to those in FIG. 1 are denoted by the same reference numerals correspondingly.

A hospital management system 200 has an anti-virus software management server 10, a network A, a plurality of medical devices 41 to 46, hospital management apparatus 30 and an operational status monitoring server 70. The hospital management apparatus 30 is connected to the plurality of medical devices 41 to 46 via a local area network B so as to manage the plurality of medical devices 41 to 46. The operational status monitoring server 70 is connected to the local area network B so as to monitor the operational status of each of the plurality of medical devices 41 to 46. The hospital management apparatus 30, the operational status monitoring server 70, the local area network B and the plurality of medical devices 41 to 46 are installed in a hospital X. The hospital management apparatus 30 may be provided outside the hospital.

The anti-virus software management server 10 makes up a latest pattern file for the anti-virus software and sends the latest pattern file to the hospital management apparatus 30 in accordance with a request from the hospital management apparatus 30.

The operational status monitoring server 70 monitors the operational status of the plurality of medical devices 41 to 46, and sends information indicating the operational status to the hospital management apparatus 30 in accordance with a request from the hospital management apparatus 30.

The plurality of medical devices 41 to 46 are devices to be used for medical applications. Each medical device includes a computer. An image management server or the like for managing medical image data such as roentgenogram data is also one of the medical devices. The medical device 41 is managed by a management agent a, the medical device 42 is managed by a management agent b, the medical devices 43 to 45 are managed by a management agent c, and the medical device 46 is managed by a management agent d. The hospital X is managed by a manager e.

The hospital management apparatus 30 has a communication portion 31, a control portion 32, a communication portion 33, a database 34, a ROM 35 and an output portion 36. The control portion 32 further includes an anti-virus unit 37, an accounting information generating unit 38 and an operation status information acquisition unit 39.

The communication portion 31 has communication with devices outside the hospital X through the network A. The anti-virus software management server 10 is one of such devices. The communication portion 33 has communication with the plurality of medical devices 41 to 46 or the operational status monitoring server 70 through the local area network B.

The control portion 32 is mainly constituted by a processor operating by a predetermined program stored in the ROM 35. The control portion 32 supervises and controls the hospital management apparatus 30 as a whole. The control portion 32 registers information (IDs for specifying the medical devices, IDs for specifying the management agents, information indicating types of the medical devices, information for specifying the contents of anti-virus measures taken for the medical devices, etc.) into the database 34. The information is input by the management agents of the plurality of medical devices 41 to 46 individually.

Anti-virus software is installed in the hospital management apparatus 30. Using the anti-virus software, the anti-virus unit 37 of the control portion 32 takes anti-virus measures for the plurality of medical devices 41 to 46 registered in the database 34, in accordance with the contents specified for each of the plurality of medical devices 41 to 46. The anti-virus measures mean that using the anti-virus software with the latest pattern file acquired from the anti-virus software management server 10, viruses in the plurality of medical devices 41 to 46 registered in the database 34 are detected, and the detected viruses are exterminated. The latest pattern file acquired from the anti-virus software management server 10 is stored in the database 34.

Each management agent a-d can specify the level to take the anti-virus measures for medical devices managed by the management agent itself. The level of the anti-virus measures can be specified through the information for specifying the contents of the anti-virus measures. In this embodiment, one pattern can be selected from two patterns, that is, a pattern in which only virus detection is carried out and a pattern in which virus scanning is carried out and detected viruses are exterminated.

Detection and Extermination of viruses in the plurality of medical devices 41 to 46 can be achieved by the control portion 32 gaining access to hard disks in the plurality of medical devices 41 to 46. To this end, the hard disks in the plurality of medical devices 41 to 46 have to be made accessible from the hospital management apparatus 30.

The accounting information generating unit 38 of the control portion 32 generates accounting information for charging each management agent a-d a fee corresponding to the contents of the anti-virus measures specified for each of the plurality of medical devices 41 to 46, based on the information indicating the contents of the anti-virus measures and stored in the database 34. Then, the control portion 32 stores the generated accounting information in the database 34.

After storing the accounting information, the operation status information acquisition unit 39 of the control portion 32 acquires information indicating the operational status of each of the plurality of medical devices 41 to 46 from the operational status monitoring server 70, and corrects the accounting information based on the acquired information. Then, the control portion 32 stores the corrected accounting information in the database 34. The corrected accounting information stored thus is output by the output portion 36 so as to be used as information for charging each management agent a-d a fee for the anti-virus measures.

Incidentally, the control portion 32 may wholly or partially be a general purpose computer containing a program corresponding to the set of instructions for the function as set forth above. For example, at least one of anti-virus unit 37, the accounting information generating unit 38 and the operation status information acquisition unit 39 can be a general purpose computer containing such a program.

In addition, The hospital management apparatus 30 may be wholly or partially located outside the hospital. For example, but not byway of limitation, at least one of the control portion 32, the database 34, the ROM 35 and the output portion 26 can be located outside the hospital.

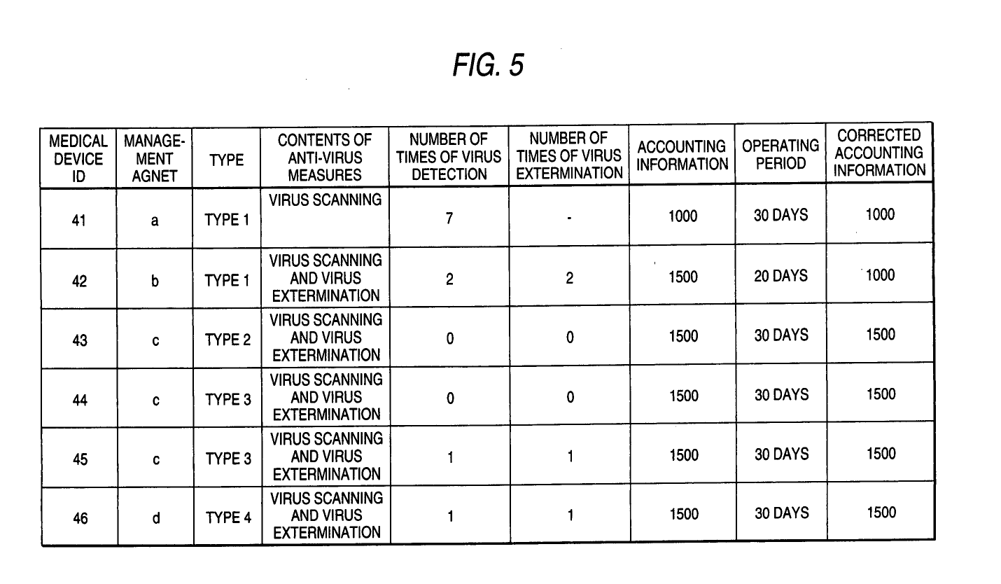

FIG. 5 is a diagram showing an example of an accounting table stored in the database 34.

As shown in FIG. 5, the database 34 stores an accounting table storing IDs of the plurality of medical devices 41 to 46, IDs of the management agents a to d managing the plurality of medical devices 41 to 46 respectively, information indicating types of the plurality of medical devices 41 to 46 respectively, information indicating the contents of anti-virus measures to be taken for each of the plurality of medical devices 41 to 46, the accounting information for accounting in accordance with the contents of the anti-virus measures, information indicating the number of times of virus detection in each of the plurality of medical devices 41 to 46, information indicating the number of times of virus detection in each of the plurality of medical devices 41 to 46, and corrected accounting information. In this embodiment, description will be made on the assumption that a fee for carrying out only virus detection as the contents of anti-virus measures is 1,000 yen per month, and a fee for virus detection and virus extermination as the contents of anti-virus measures is 1,500 yen per month.

The information indicating the types is information indicating the kind of OS (Operating System) in the computer of each of the plurality of medical devices 41 to 46, or information indicating the applications etc. of the plurality of medical devices 41 to 46.

The output portion 36 outputs the accounting information or information indicating the past records (the number of times of virus detection and the number of times of virus extermination) of the anti-virus measures. For example, the output portion 36 prints out the accounting information or the information indicating the past records of the anti-virus measures on paper.

Description will be made below about the operation of the hospital management system 200.

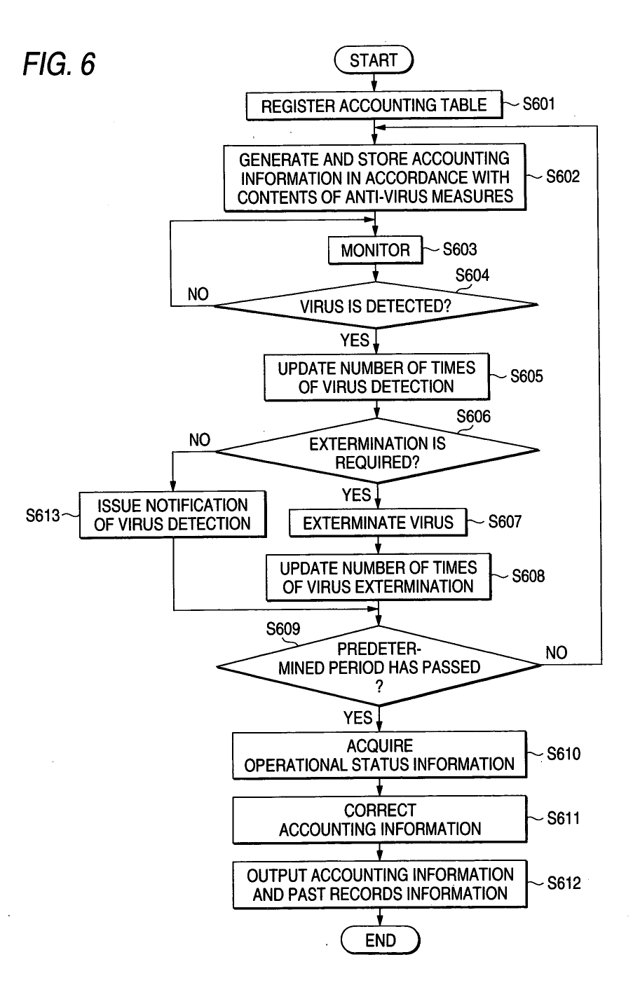

FIG. 6 is a flow chart for explaining the operation of the hospital management system 200.

First, each management agent a-d uses its own PC (personal computer) or the like to gain access to the hospital management apparatus 30 through the network B, so as to input IDs of medical devices managed by the management agent, an ID of the management agent, information of types of the medical devices, and information for specifying the contents of anti-virus measures to the hospital management apparatus 30. The control portion 32 of the hospital management apparatus 30 makes up an accounting table based on the input information, and registered the accounting table into the database 34 (S601). After the registration, the control portion 32 generates accounting information for charging each management agent a-d a fee corresponding to the contents of the anti-virus measures for each of the plurality of medical devices 41 to 46, based on the accounting table, and stores the accounting information in the accounting table (S602).

As the contents of the anti-virus measures, in the example of FIG. 5, virus scanning is assigned to the medical device 41, while virus scanning and virus extermination are assigned to the medical devices 42 to 46. Therefore, accounting information for charging the management agent a 1,000 yen, the management agent b 1,500 yen, the management agent c 4,500 yen, and the management agent d 1, 500 yen, is generated and stored.

After storing the accounting information, the anti-virus unit 37 of the control portion 32 gains access to the anti-virus software management server 10 via the communication portion 31 and the network A periodically (for example, every six hours) When the pattern file is updated, the anti-virus unit 37 of the control portion 32 performs a pattern file acquisition process for acquiring the latest pattern file from the anti-virus software management server 10 via the network A and the communication portion 31.

In parallel to the pattern file acquisition process, the anti-virus unit 37 of the control portion 32 gains periodic access to the medical devices registered in the database 34. Thus, the control portion 32 monitors the accessed medical devices so as to detect viruses invading the medical devices by use of the anti-virus software and the latest pattern file stored in the database 34 (S603).

When the control portion 32 detects a virus in one accessed medical device (for example, the medical device 42) (S604: YES), the control portion 32 updates, of the items in the accounting table, the item about the number of times of virus detection of the medical device 42 (S605). Then, the control portion 32 determines whether virus extermination is assigned to the medical device 42 or not, based on the information indicating the contents of the anti-virus measures in the accounting table (S606).

In the example of FIG. 5, it is necessary to perform virus extermination on the medical device 42. Therefore, the control portion 32 exterminates the detected virus by use of the latest pattern file and the anti-virus software (S607). On the other hand, when only virus scanning is assigned to the medical device 42 according to the contents of the anti-virus measures (S606: NO), the control portion 32 notifies the medical device 42 of the virus detection (S613), and moves the process to S609.

After the virus extermination, the control portion 32 updates, of the items in the accounting table, the item about the number of times of virus extermination of the medical device 42 (S608) The control portion 32 determines whether a predetermined period (for example, one month) has passed since the accounting table was registered in the database 34 or not (S609). The steps S603 to S609 are repeated till the predetermined period has passed.

When the predetermined period has passed since the accounting table was registered in the database 34 (S609: YES), the operation status information acquisition unit 39 of the control portion 32 gains access to the operational status monitoring server 70 so as to acquire information indicating the operational status of each of the plurality of medical devices 41 to 46 for the predetermined period (S610). The control portion 32 corrects the accounting information stored in S602, based on the acquired information indicating the operational status (S611).

In the example of FIG. 5, the operating period of the medical device 42 is 20 days, and the operating period of each of the other medical devices is 30 days. The control portion 32 calculates the ratio of the operating period to the predetermined period, and corrects the accounting information based on the ratio. When the predetermined period is 30 days, the ratio of the operating period to the predetermined period is 2/3 in the medical device 42. Therefore, the control portion 32 obtains the value 1,000 by multiplying the value 1,500 in the accounting information of the medical device 42 by the ratio 2/3, and sets the obtained value 1,000 in the corrected accounting information of the medical device 42.

After correcting the accounting information, the control portion 32 makes the output portion 36 output the corrected accounting information and the information indicating the past records of the anti-virus measures such as the number of times of virus detection and the number of times of virus extermination in each of the plurality of medical devices 41 to 46 (S612). As a result, a report in which the accounting information and the information indicating the past records of the anti-virus measures in each of the plurality of medical devices 41 to 46 have been printed can be presented to each management agent a-d.

Thus, according to the hospital management system 200, the hospital management apparatus 30 acquires the latest pattern file, and performs virus scanning and extermination in the plurality of medical devices 41 to 46 by use of the acquired pattern file and the anti-virus software. Then, the hospital management apparatus 30 generates accounting information for charging each of the management agents a to d of the plurality of medical devices 41 to 46 a fee corresponding to the contents of the anti-virus measures.

Thus, each of the plurality of medical devices 41 to 46 can take anti-virus measures sufficiently without gaining periodic access to the anti-virus software management server 10 individually. It is therefore possible to secure safety in information handled in the hospital. In addition, it is possible to charge each of the management agents of the plurality of medical devices 41 to 46 a fee corresponding to the contents of the anti-virus measures for each of the plurality of medical devices 41 to 46 based on the accounting information. Thus, each management agent managing a plurality of medical devices does not have to manage expenses required for anti-virus measures for the plurality of medical devices. It is therefore possible to relieve the burden on the management agent. In addition, it is not necessary to install the anti-virus software in the plurality medical devices 41 to 46. It is therefore possible to cover devices etc. where the anti-virus software cannot be installed, while it is possible to reduce the processing load on the plurality of medical devices 41 to 46. Further, the accounting information can be corrected based on the operational status of each of the plurality of medical devices 41 to 46. It is therefore possible to discount the expenses for the anti-virus measures for a medical device that has not operated for a long time.

Although the accounting information is corrected based on the operational status of each of the plurality of medical devices 41 to 46 in the this embodiment, the control portion 32 of the hospital management apparatus 30 may store information indicating the operational status of the apparatus into the database 34 so as to correct the accounting information in accordance with the operational status of the apparatus.

In addition, in this embodiment, the aforementioned predetermined period may be set for each of the management agents a to d individually.

In addition, in this embodiment, of the plurality of medical devices registered in the database 34, some specific medical devices may be set so that the anti-virus measures are taken thereon without charge.

Although the accounting information for accounting in accordance with the contents of the anti-virus measures is generated in this embodiment, accounting information for accounting in accordance with the number of medical devices to be subjected to the anti-virus measures regardless of the contents of the anti-virus measures may be generated.

For example, as soon as the accounting table is registered in S601 of FIG. 6, the control portion 32 generates accounting information for charging each management agent a-d a fee corresponding to the number of medical devices managed by the management agent a-d, based on the accounting table, and stores the accounting information into the data base 34. In this case, the steps S610 and S611 in FIG. 6 are omitted, and in S612 the generated accounting information is output together with the information indicating the past records of the anti-virus measures. Description will be made using the example of FIG. 5 on the assumption that a fee to be charged for anti-virus measures on one medical device is 1,000 yen per month. Since the management agent c manages three medical devices, the control portion 32 generates accounting information for charging the management agent c 3,000 yen per month, and generates accounting information for charging each of the other management agents 1,000 yen per month.

When the manager e has been set as the user to be charged, as soon as the accounting table is registered in S601 of FIG. 6, the control portion 32 obtains the number of the plurality of medical devices 41 to 46 and generates accounting information for charging the manager e a fee corresponding to the obtained number, based on the accounting table. Then, the control portion 32 stores the accounting information into the database 34. In this case, the steps S610 and S611 in FIG. 6 are omitted, and in S612 the generated accounting information is output together with the information indicating the past records of the anti-virus measures. Description will be made using the example of FIG. 5 on the assumption that a fee to be charged for anti-virus measures on one medical device is 1,000 yen per month. Since the number of the plurality of medical devices 41 to 46 is six, the control portion 32 generates accounting information for charging the manager e 6,000 yen per month.

Alternatively, accounting information for accounting in accordance with the number of types of medical devices to be subjected to the anti-virus measures regardless of the past records of the anti-virus measures may be generated.

For example, as soon as the accounting table is registered in S601 of FIG. 6, the control portion 32 generates accounting information for charging each management agent a-d a fee corresponding to the number of types of medical devices managed by the management agent a-d, based on the accounting table, and stores the accounting information into the database 34. In this case, the steps S610 and S611 in FIG. 6 are omitted, and in S612 the generated accounting information is output together with the information indicating the past records of the anti-virus measures. Description will be made using the example of FIG. 5 on the assumption that a fee to be charged for anti-virus measures on one medical device type is 1,000 yen per month. Since the management agent c manages two types of medical devices, the control portion 32 generates accounting information for charging the management agent c 2,000 yen per month, and generates accounting information for charging each of the other management agents 1,000 yen per month.

When the manager e has been set as the user to be charged, as soon as the accounting table is registered in S601 of FIG. 6, the control portion 32 obtains the total number of types of the plurality of medical devices 41 to 46 and generates accounting information for charging the manager e a fee corresponding to the obtained total number, based on the accounting table. Then, the control portion 32 stores the accounting information into the database 34. In this case, the steps S610 and S611 in FIG. 6 are omitted, and in S612 the generated accounting information is output together with the information indicating the past records of the anti-virus measures. Description will be made using the example of FIG. 5 on the assumption that a fee to be charged for anti-virus measures on one medical device type is 1,000 yen per month. Since the plurality of medical devices 41 to 46 include four types, the control portion 32 generates accounting information for charging the manager e 4,000 yen per month. It can be considered that different types of anti-virus software are installed in medical devices in accordance with types of the medical devices. Therefore, accounting in accordance with the number of types in such a manner can be regarded as a useful service.

According to the invention, it is possible to provide hospital management apparatus which is capable of relieving the burden imposed on management agents for anti-virus measures taken on medical devices installed in a hospital, and which is capable of protecting information in the hospital.

The entire disclosure of each and every foreign patent application from which the benefit of foreign priority has been claimed in the present application is incorporated herein by reference, as if fully set forth.

1. A hospital management apparatus connected to a plurality of medical devices installed in a hospital through a local area network so as to manage said plurality of medical devices, said hospital management apparatus comprising:
an anti-virus unit that provides anti-virus measures for said plurality of medical devices; and
an accounting information generating unit that generates accounting information for accounting in accordance with the anti-virus measures.

2. A hospital management apparatus according to claim 1, further comprising:
a storage unit that stores past records information indicating past records of the anti-virus measures;
wherein the accounting information generating unit generates the accounting information for accounting in accordance with the past records of the anti-virus measures, based on the past records information stored in the storage unit.

3. A hospital management apparatus according to claim 2,
wherein anti-virus software is installed in said plurality of medical devices;
the anti-virus unit acquires a latest pattern file made up for the anti-virus software, and sends the pattern file to requesting one(s) of said plurality of medical devices via the local area network;
the past records information includes information indicating a number of times of sending the pattern file to each of said plurality of medical devices; and
the accounting information generating unit generates the accounting information for charging each of management agents of said plurality of medical devices a fee corresponding to the number of times of sending the pattern file for each of said plurality of medical devices.

4. A hospital management apparatus according to claim 2,
wherein anti-virus software is installed in each of said plurality of medical devices;
the anti-virus unit acquires a latest pattern file made up for the anti-virus software, and sends the pattern file to requesting one(s) of said plurality of medical devices via the local area network;
the past records information includes information indicating a number of times of sending the pattern files; and
the accounting information generating unit generates accounting information for charging a manager of the hospital a fee corresponding to the number of times of sending the pattern files.

5. A hospital management apparatus according to claims 2, further comprising:
an output unit that outputs the past records information stored in the storage unit.

6. A hospital management apparatus according to claim 1, further comprising:
a storage unit that stores measures contents information for specifying contents of anti-virus measures to be taken for each of said plurality of medical devices,
wherein the anti-virus unit provides the anti-virus measures in accordance with the contents specified by the measures contents information stored in the storage unit; and
the accounting information generating unit generates the accounting information for charging each of management agents of said plurality of medical devices a fee corresponding to the contents of the anti-virus measures specified for each of said plurality of medical devices, based on the measures contents information stored in the storage unit.

7. A hospital management apparatus according to claim 6, wherein
no anti-virus software is installed in each of said plurality of medical devices;
the anti-virus software is installed in the hospital management apparatus; and
the contents of the anti-virus measures include acquisition of a latest pattern file made up for the anti-virus software, detection of viruses in said plurality of medical devices by means of the pattern file, and extermination of the detected viruses in said plurality of medical devices by means of the pattern file.

8. A hospital management apparatus according to claim 6, further comprising:
an operational status information acquisition unit that acquires operational status information indicating operational status of each of said plurality of medical devices from a server for monitoring the operational status of each of said plurality of medical devices, the server being connected to the local area network;
wherein the accounting information generating unit corrects the generated accounting information in accordance with the operational status based on the operational status information.

9. A hospital management apparatus according to claim 6, wherein the accounting information generating unit corrects the generated accounting information in accordance with operational status of the hospital management apparatus.

10. A hospital management apparatus according to claim 1, further comprising:
a storage unit that stores medical device information indicating management agents of said plurality of medical devices individually;
wherein the accounting information generating unit generates the accounting information for charging each of the management agents a fee corresponding to a number of medical devices managed by the management agents, based on medical device information stored in the storage unit.

11. A hospital management apparatus according to claim 1,
wherein the accounting information generating unit generates the accounting information for charging a manager of the hospital a fee corresponding to a number of said plurality of medical devices.

12. A hospital management apparatus according to claim 1, further comprising:
a storage unit that stores medical device information indicating kinds and management agents of said plurality of medical devices individually;
wherein the accounting information generating unit generates accounting information for charging each of the management agents a fee corresponding to a number of kinds of medical devices managed by the management agents, based on the medical device information stored in the storage unit.

13. A hospital management apparatus according to claim 1, further comprising:
a storage unit that stores medical device information indicating kinds of said plurality of medical devices individually;
wherein the accounting information generating unit generates accounting information for charging a manager of the hospital a fee corresponding to a number of kinds of said plurality of medical devices, based on medical device information stored in the storage unit.

14. A hospital management apparatus according to claim 6, further comprising:
an output unit that outputs information indicating past records of the anti-virus measures taken by the anti-virus unit.

15. A hospital management apparatus according to claim 10, further comprising:
an output unit that outputs information indicating past records of the anti-virus measures taken by the anti-virus unit.

16. A hospital management apparatus according to claim 11, further comprising:
an output unit that outputs information indicating past records of the anti-virus measures taken by the anti-virus unit.

17. A hospital management apparatus according to claim 12, further comprising:
an output unit that outputs information indicating past records of the anti-virus measures taken by the anti-virus unit.

18. A hospital management apparatus according to claim 13, further comprising:
an output unit that outputs information indicating past records of the anti-virus measures taken by the anti-virus unit.

19. A hospital management apparatus connected to a plurality of medical devices installed in a hospital through a local area network so as to manage said plurality of medical devices, said hospital management apparatus comprising:
means for providing anti-virus measures for said plurality of medical devices; and
means for generating accounting information for accounting in accordance with the anti-virus measures.

20. A hospital management method for managing a plurality of medical devices installed in a hospital, the method comprising:
connecting at least one of said plurality of medical devices through a local area network, to provide anti-virus measures for said at least one of said plurality of medical devices; and
generating accounting information for accounting in accordance with the anti-virus measures.

21. A computer-readable medium including set of instructions for managing a plurality of medical devices installed in a hospital, said set of instructions comprising:
connecting at least one of said plurality of medical devices through a local area network, to provide anti-virus measures for said at least one of said plurality of medical devices; and
generating accounting information for accounting in accordance with the anti-virus measures.
